(19) United States
(12) Patent Application Publication
(10) Pub. No.: US 2007/0129897 A1
(43) Pub. Date: Jun. 7, 2007

(54) System and method of facilitating animal propagation

(75) Inventors: Casey Werrell, Leander, TX (US); E. Duane Heady, San Antonio, TX (US)

Correspondence Address: Daniel D. Chapman;Jackson Walker L.L.P., Suite 2400, 112 E. Pecan, San Antonio, TX, 78205, US

(73) Assignee: Bull's Eye Solutions, LLC

(21) Appl. No.: 11/293,537

(22) Filed: Dec. 2, 2005

(51) Int. Cl. G06F 19/00; G06Q 10/00

(52) U.S. Cl. 702/20; 705/1

(57) ABSTRACT

The present invention provides a system and method of facilitating animal propagation. In one embodiment, the present invention utilizes data relating to the traits or characteristics exhibited by the offspring of one or more animals. Such data is utilized to calculate the likelihood and/or probability that a pair of animals will produce offspring having one or more desirable characteristics. The present invention allows the user to enter preferences regarding one or more offspring traits. In one embodiment, the user may prioritize one or more traits such that greater weight is given during calculation. Traits may also be maximized, minimized or optimized in order to address the needs of each individual user. Results may also be displayed and ranked according to one or more user preferences.

### FIELD OF THE INVENTION

The present invention relates generally to animal propagation, and more particularly to a system and method of facilitating animal propagation.

### BACKGROUND OF THE INVENTION

Animal owners have continually wrestled with the inconsistency and uncertainty of known breeding techniques. In many cases, animal owners select animals for breeding based upon visual inspection of their animals. In short, a male and a female are selected based upon one or more observed desirable traits in the hopes that the male and female, if bred to one another, will produce offspring having similar traits. Unfortunately, such techniques are unreliable and time consuming.

As such, there remains a need for a system and method capable of reducing the uncertainty associated with animal breeding.

### SUMMARY OF THE INVENTION

Accordingly, the present invention provides a system and method of facilitating animal propagation. In one embodiment, the present invention utilizes data relating to the traits or characteristics exhibited by the offspring of one or more animals. Such data is utilized to calculate the likelihood and/or probability that a pair of animals will produce offspring having one or more desirable characteristics.

In one embodiment, the calculations made possible by the unique functionality of the present invention are performed with the assistance of a computer or other electronic device. In one embodiment, the present invention provides a web-based software application designed to interact with remote users via a computer network.

Users of the present invention are provided with an attractive graphic user interface through which they may enter animal information into the system. In one embodiment, such information may be categorized and stored according to ranch, herd, or pasture. In one embodiment, the present invention utilizes progeny predictors relating to a plurality of animals.

Upon selection of a mating pair, the present invention utilizes progeny predictors associated with each animal to estimate the progeny predictors most likely to be associated with the potential offspring of the mating pair. In one embodiment, the calculation performed by the present invention involves taking the average of the progeny predictors of the mating pair. The averaged progeny predictors of the mating pair provides an estimation of the likely progeny predictors to be exhibited by the offspring of the mating pair, should the user decide to breed these animals.

The present invention allows the user to enter preferences regarding one or more offspring traits. In one embodiment, the user may emphasize one or more traits such that greater weight is given during calculation. Traits may also be maximized, minimized, or optimized in order to address the needs of each individual user. Results may also be displayed and ranked according to one or more user preferences.

### BRIEF DESCRIPTION OF THE DRAWINGS

A more complete appreciation of the invention and many of the attendant advantages thereof will be readily obtained as the same becomes better understood by reference to the following detailed description when considered in connection with the accompanying drawings; it being understood that the drawings contained herein are not necessarily drawn to scale; wherein:

FIG. 1 is a component diagram of one embodiment of the present invention.

FIG. 2 is a flow chart diagram illustrating one embodiment of the present invention.

FIG. 3 is a flow chart diagram illustrating one embodiment of the present invention.

FIGS. 4-12 are screen shots illustrating the graphic user interface of one embodiment of the present invention.

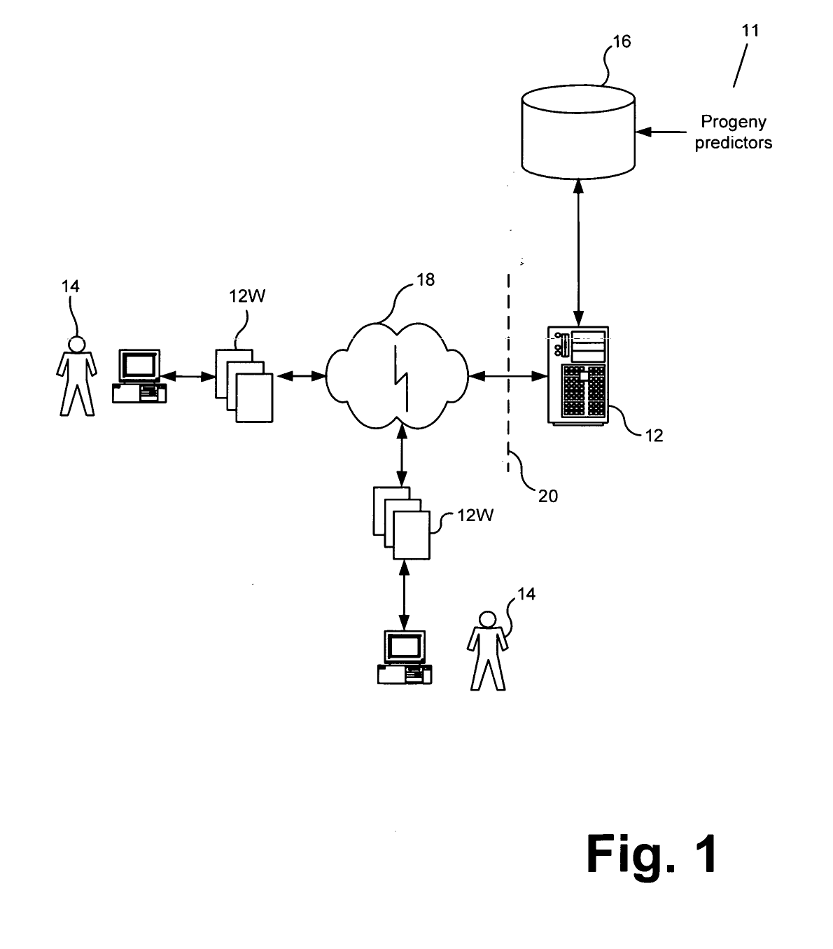

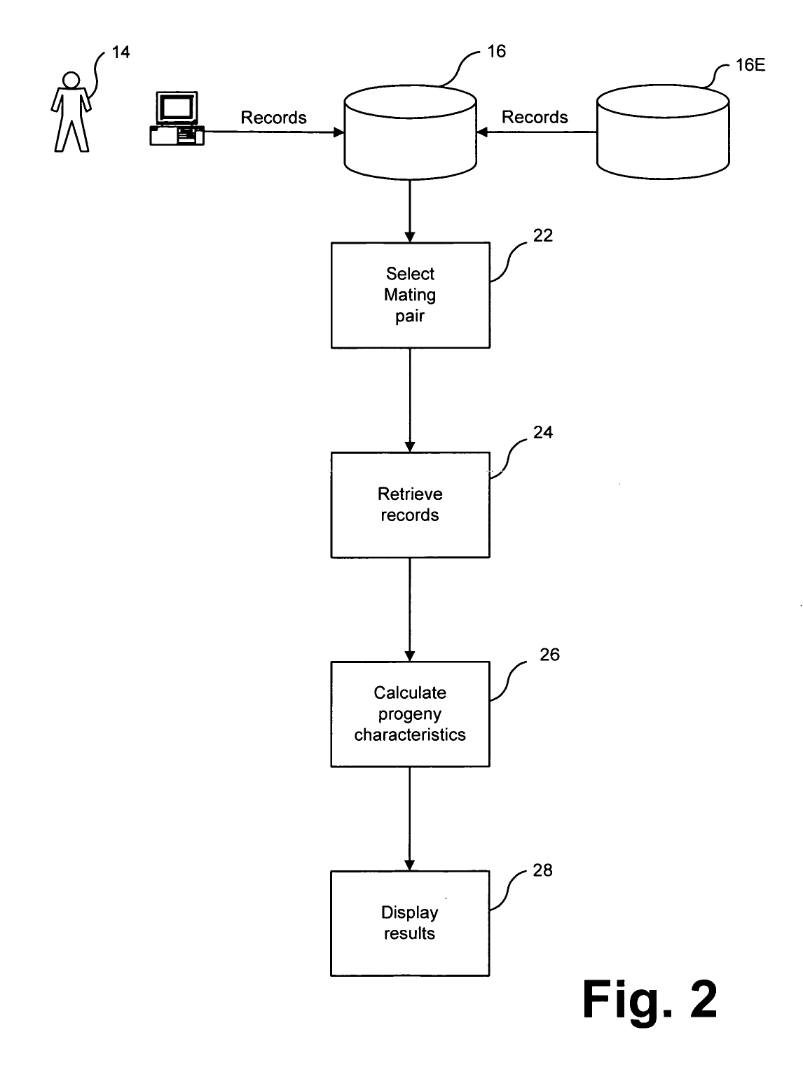

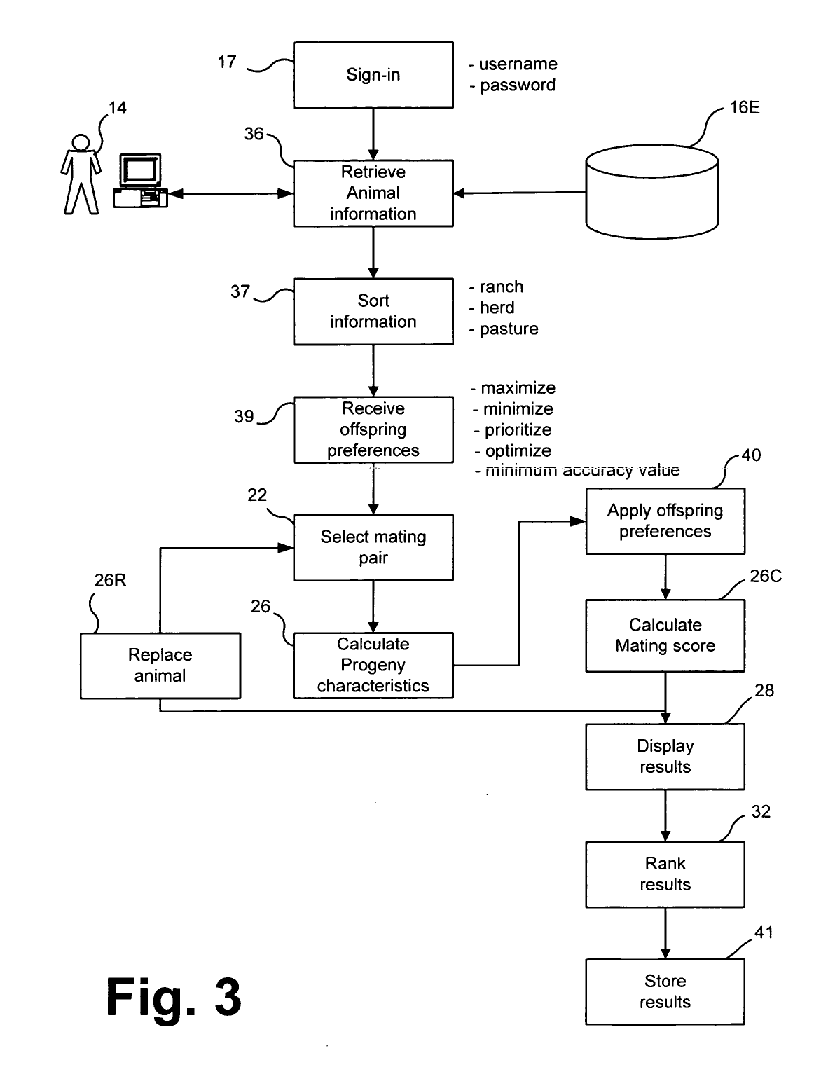

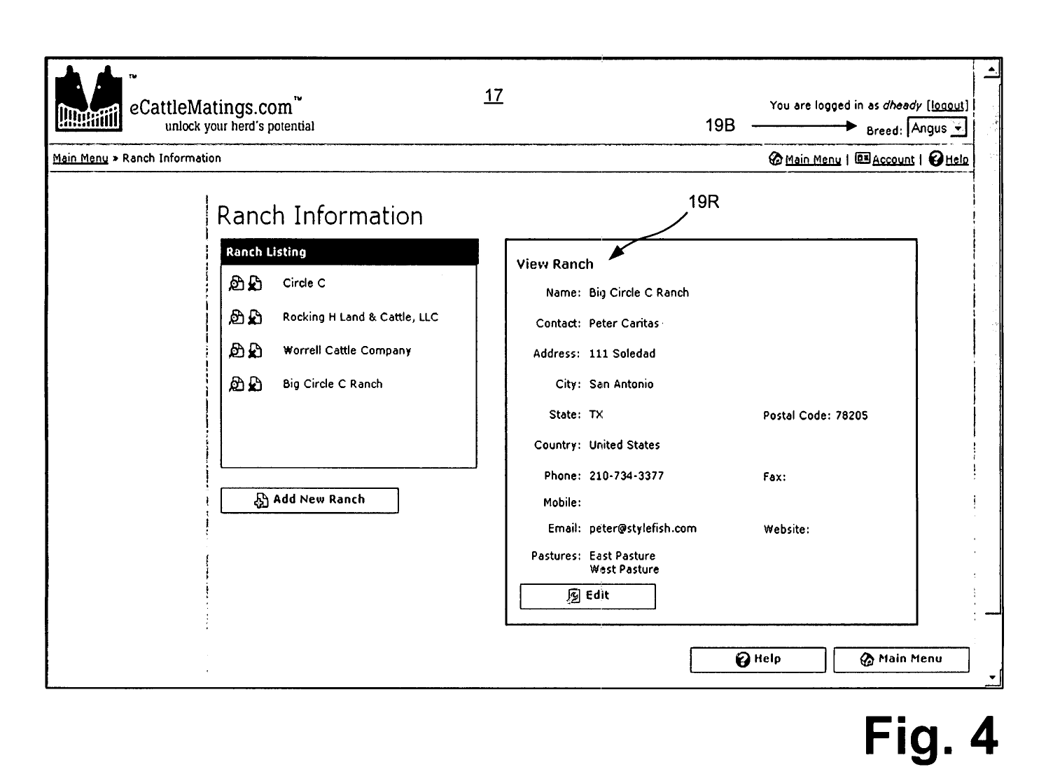

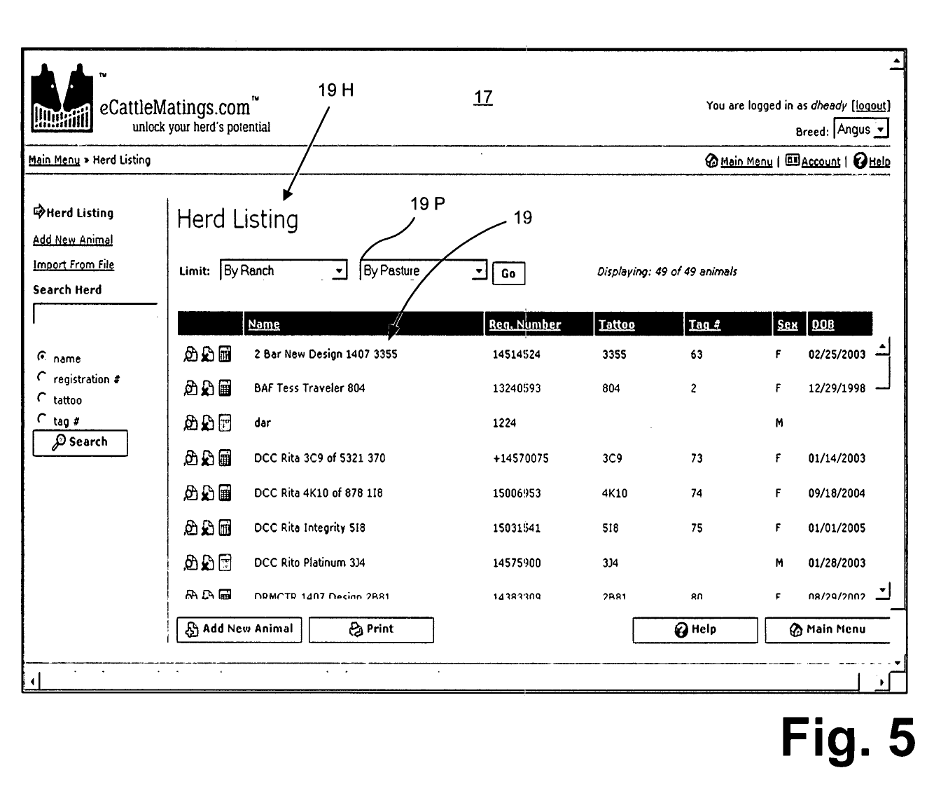

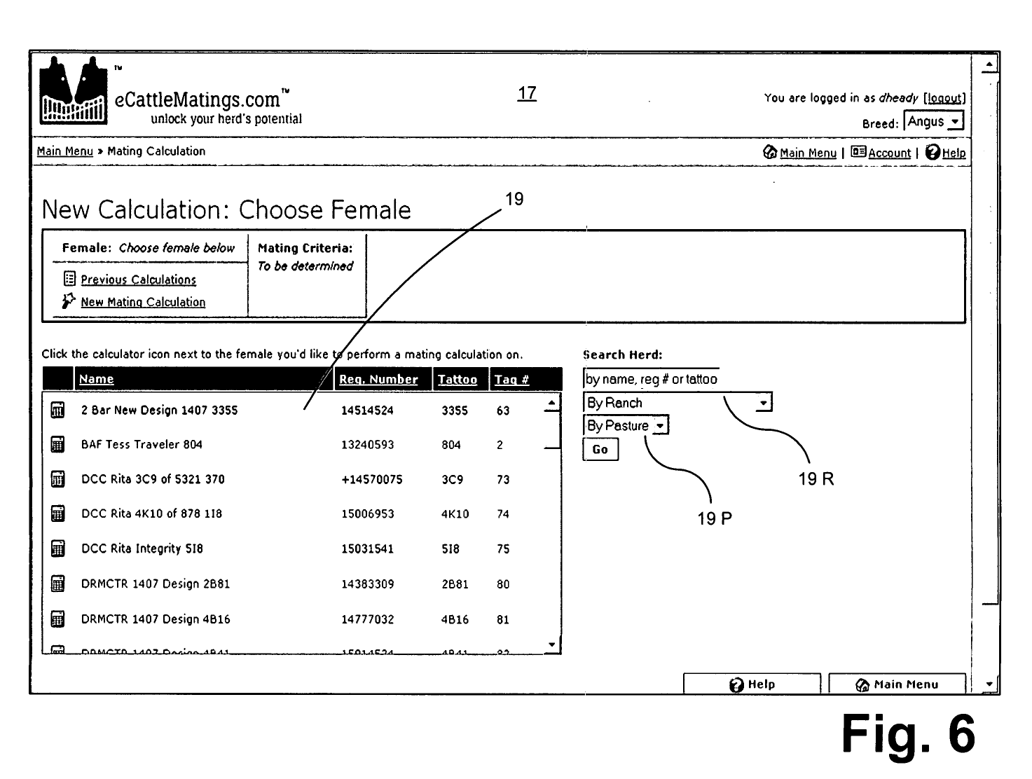

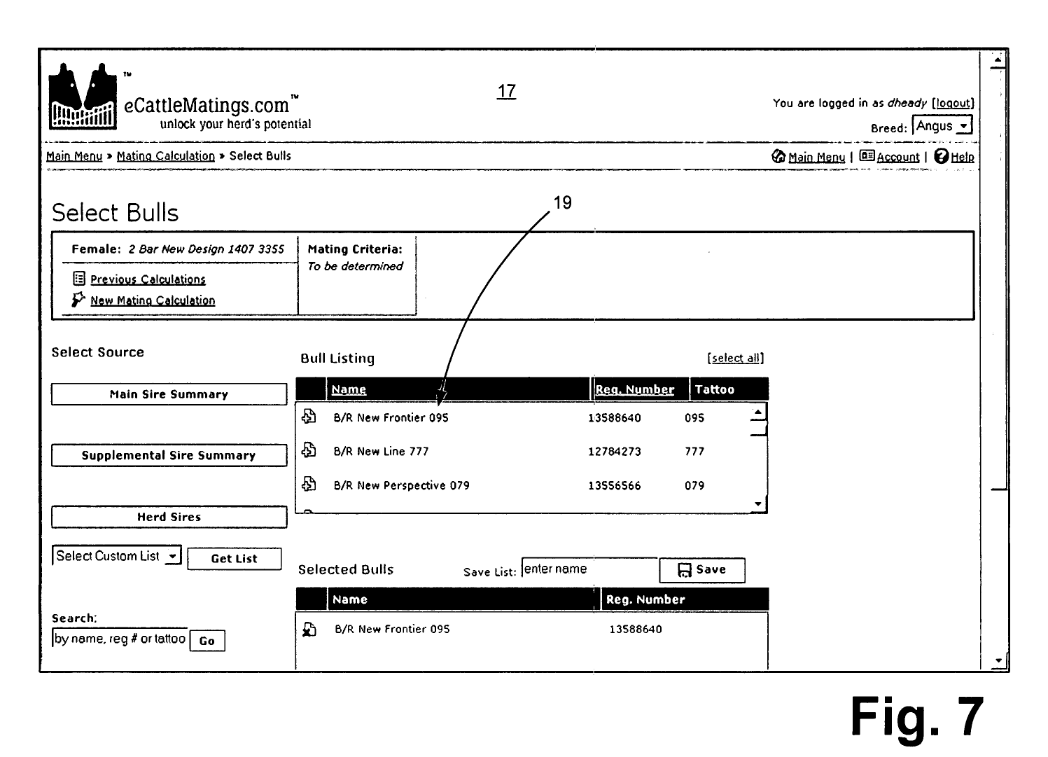

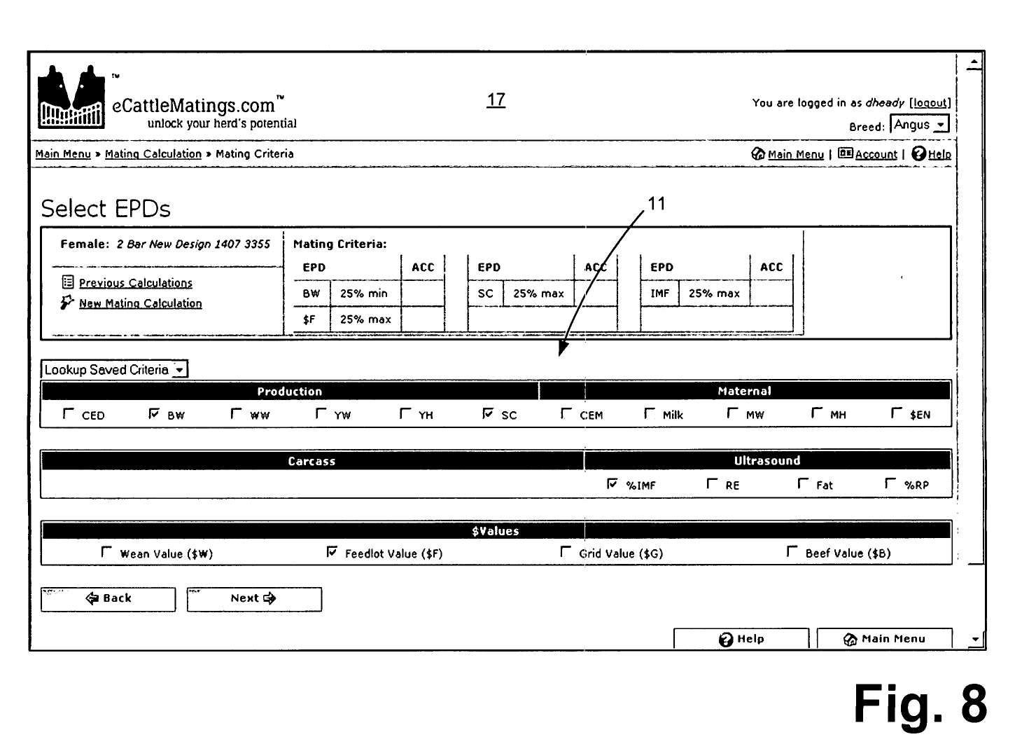

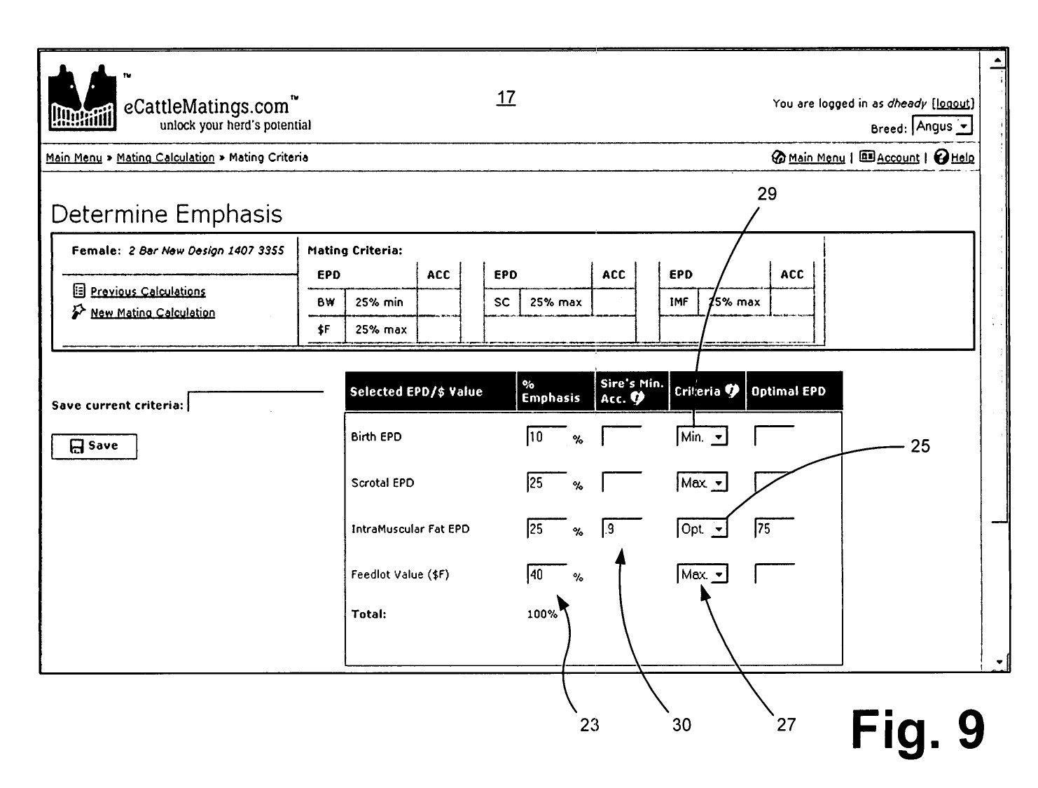

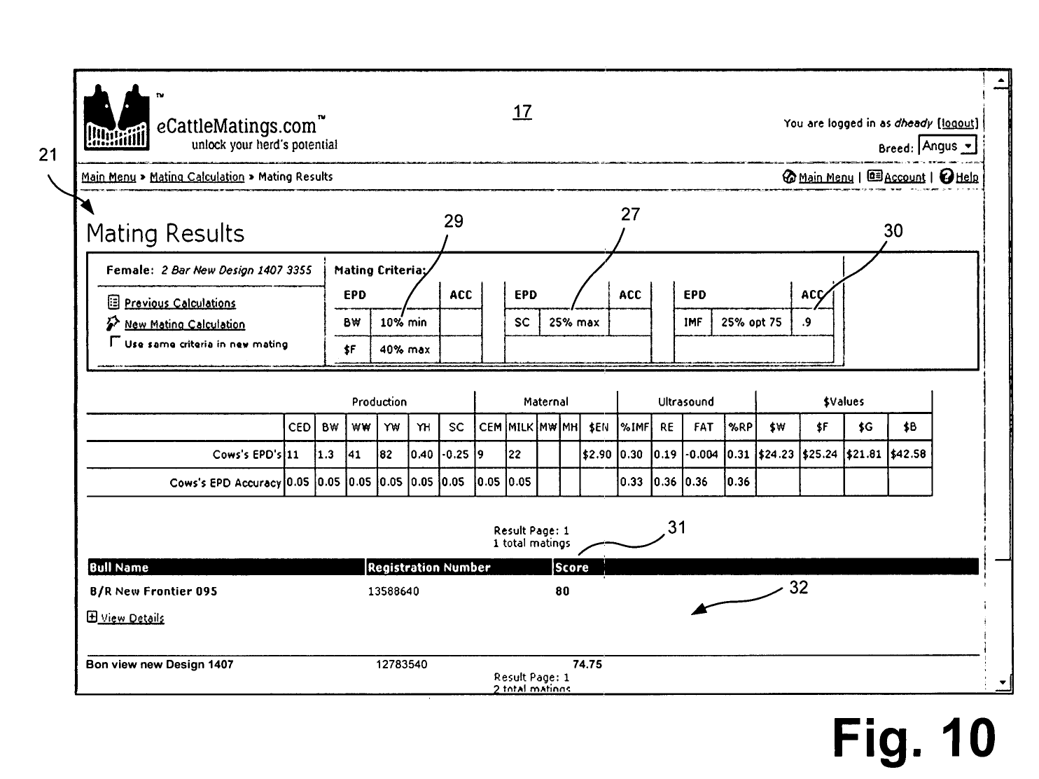

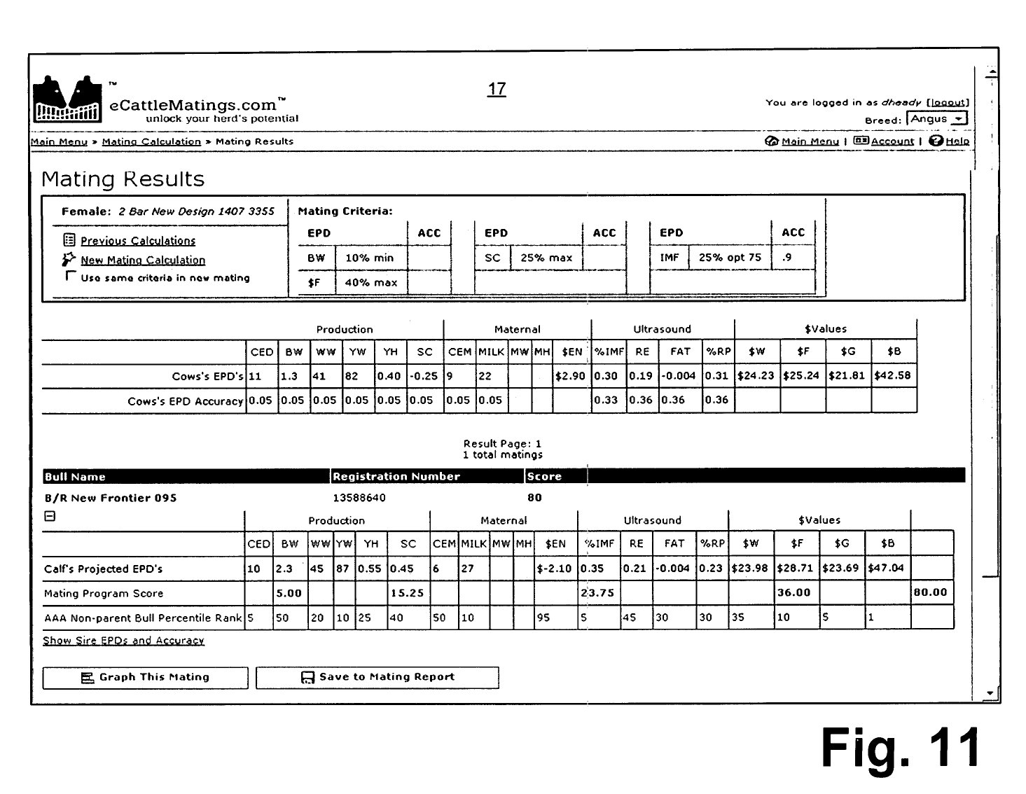

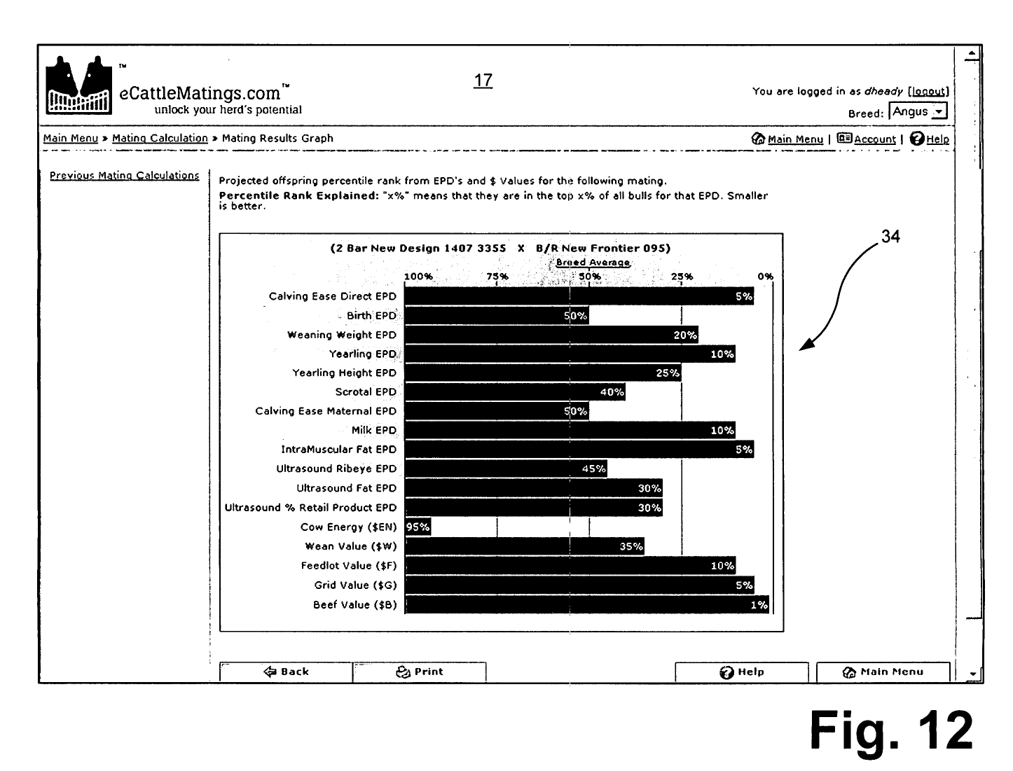

It is to be noted, however, that the appended drawings illustrate only typical embodiments of this invention and are therefore not to be considered limiting of its scope, for the invention may admit to other equally effective embodiments.

### DETAILED DESCRIPTION OF THE INVENTION

In the following description, numerous details are set forth to provide an understanding of the present invention. However, it will be understood by those skilled in the art that the present invention may be practiced without these details and that numerous variations or modifications from the described embodiments may be possible.

The present invention is herein described as a system and method of facilitating animal propagation. Referring to the Figures, the present invention is designed to utilize records pertaining to the offspring of a plurality of animals. In one embodiment, such records contain data relating to individual animals and their offspring. Records may contain information relating to individual animal characteristics and/or traits. Characteristics and/or traits may encompass any animal quality worthy of consideration in making a mating determination, i.e., determining which male and female should be bred.

Records utilized by the present invention may be compiled and/or obtained in any reliable manner. In one embodiment, animal records compiled by reputable organizations, such as the American Angus Association, may be utilized. Such information is utilized to assist animal owners and other interested parties in making an informed mating determination.

Upon selection of a mating pair, the present invention utilizes progeny predictors (11) associated with each animal to estimate the likelihood that the potential offspring of the mating pair will exhibit one or more desirable characteristics. In one embodiment, progeny predictors are predictions of the qualities of future offspring relative to the offspring of other animals.

In one embodiment, the calculation performed by the present invention involves taking the average of the progeny predictors of the mating pair. The averaged progeny predictors of the mating pair provides an estimation of the likely progeny predictors to be exhibited by the offspring of the mating pair, should the user decide to breed these animals.

In one embodiment, the present invention may be embodied in one or more software applications capable of operating upon any number of hardware arrangements including, but not limited to, stand-alone devices and wireless devices. Such software applications may be loaded upon a computer system via any number of known methods, such as via CD-ROM or download via a computer network.

The present invention provides a processing unit (12) capable of accessing electronic records. Further, the processing unit has access to a plurality of web pages (12W) designed to assist remote users (14) in accessing the unique functionality of the present invention. In one embodiment, electronic records utilized by the processing unit of the present invention may be stored locally upon a storage device (16) and/or accessed through an external storage medium (16E). Access to the present invention may be provided via a computer network (18). Further, firewalls (20) may be utilized to control access to the processing unit and/or protect the system against harmful viruses.

In one embodiment, the present invention is accessible through an internet browser capable of connecting to the system via a computer network. Users are provided with a sign up procedure in which they provide identifying information and are assigned a username and password to ensure secure access, as illustrated by Box (17). Any number of internet browser applications may be utilized, including, but not limited to, those provided by Microsoft® and Netscape®.

Any number of known computer systems and/or electronic devices having internet access capability may load and display the web pages (12W) provided by the present invention. In one embodiment, the processing unit of the present invention contains a number of software packages designed to facilitate effective interaction with the user through his or her internet browser.

The present invention may receive animal information from a number of sources, as illustrated by Box (36). In one embodiment, the present invention receives input information from remote users (14) pertaining to animals in their possession, control, or ownership. In this way, the present invention is ideally suited for use by ranchers and other animal owners.

In one embodiment, the storage device(s) of the present invention may also maintain and utilize animal information provided from external sources. As described above, a number of reputable organizations maintain information pertaining to particular types of animals. For example, the American Angus Association compiles animal information provided to them by ranchers around the country to generate progeny predictors commonly referred to as Expected Progeny Differences (EPDs). The graphic user interface (17) of the present invention provides a breed tab (19B) through which the user may select industry information for any number of animal breeds. In the examples provided herein involving the American Angus Association, the user would select “angus” upon the breed tab.

The progeny predictors utilized by the present invention vary depending on the type of animal at issue. Although the examples provided herein are directed to bovine animals, it should be understood that the functionality of the present invention may be applied to any number of types of animals. Further, the present invention may be utilized by breeders and/or animal owners utilizing any number of breeding techniques including, but not limited to, artificial insemination, natural service, and embryo transfer. In one embodiment, the present invention provides separate data entry registries for entry of animal information pertaining to animals subject to varying breeding techniques.

In one embodiment, the present invention utilizes one or more of the following progeny predictors: calving ease direct, birth weight, weaning weight, yearling weight, yearling height, scrotal circumference, calving ease maternal, maternal milk, mature weight, mature height, energy value, carcass weight, marbling, ribeye area, percent retail product, intramuscular fat, fat thickness, weaned value, feedlot value, grid value, and/or beef value.

Calving Ease Direct (CED) is expressed as a difference in percentage of unassisted births, with a higher value indicating greater calving ease in first-calf heifers. CED predicts the average difference in ease with which an animal's calves will be born when bred to first-calf heifers. Birth Weight (BW), expressed in pounds, is a predictor of an animal's ability to transmit birth weight to his progeny compared to that of other animals. Weaning Weight (WW), expressed in pounds, is a predictor of an animal's ability to transmit weaning growth to his progeny compared to that of other animals. Yearling Weight (YW), expressed in pounds, is a predictor of an animal's ability to transmit yearling growth to his progeny compared to that of other animals.

Yearling Height (YH) is a predictor of an animal's ability to transmit yearling height, expressed in inches, compared to that of other animals. Scrotal Circumference (SC), expressed in centimeters, is a predictor of the difference in the animal's transmitting ability for scrotal size compared to that of other animals. Calving Ease Maternal (CEM) is expressed as a difference in percentage of unassisted births with a higher value indicating greater calving ease in first-calf daughters. It predicts the average ease with which an animal's daughters will calve as first-calf heifers when compared to daughters of other animals.

Maternal Milk (Milk) is a predictor of an animal's genetic merit for milk and mothering ability as expressed in its daughters as compared to daughters of other animals. In other words, it is that part of a calfs weaning weight attributed to milk and mothering ability. Mature Weight EPD (MW), expressed in pounds, is a predictor of the difference in mature weight of daughters of an animal compared to the daughters of other animals.

Mature Height (MH), expressed in inches, is a predictor of the difference in mature height of an animal's daughters compared to daughters of other animals. Energy Value ($EN), expressed in dollars savings per animal per year, assesses differences in animal energy requirements as an expected dollar savings difference in daughters of animals. A larger value is more favorable when comparing two animals (more dollars saved on feed energy expenses). Components for computing the $EN savings difference include lactation energy requirements and energy costs associated with differences in mature animal size.

Carcass Weight (CW), expressed in pounds is a predictor of the differences in hot carcass weight of an animal's progeny compared to progeny of other animals. Marbling (Marb), expressed as a fraction of the difference in USDA marbling score of an animal's progeny compared to progeny of other animals. Ribeye Area (RE), expressed in square inches, is a predictor of the difference in ribeye area of an animal's progeny compared to progeny of other animals. Fat Thickness (Fat), expressed in inches, is a predictor of the differences in external fat thickness at the 12th rib (as measured between the 12th and 13th ribs) of an animal's progeny compared to progeny of other animals.

Weaned Value ($W), is an index value expressed in dollars per head, is the expected average difference in future progeny performance for pre-weaning merit. $W includes both revenue and cost adjustments associated with differences in birth weight, weaning direct growth, maternal milk, and mature animal size.

Feedlot Value ($F), is an index value expressed in dollars per head, is the expected average difference in future progeny performance for post-weaning merit compared to progeny of other animals. Grid Value ($G), an index value expressed in dollars per head, is the expected average difference in future progeny performance for carcass grid merit compared to progeny of other animals.

Beef Value ($B), is an index value expressed in dollars per head, is the expected average difference in future progeny performance for post-weaning and carcass value compared to progeny of other animals. $Value indexes are multi-trait selection indexes, expressed in dollars per head, to assist beef producers by adding simplicity to genetic selection decisions. The $Value is an estimate of how future progeny of each animal are expected to perform, on average, compared to progeny of other animals in the database if the animal were randomly mated and if offspring calves were exposed to the same environment.

In one embodiment, the present invention may also utilize one or more of the following progeny predictors: total maternal, mature cow maintenance energy requirements, heifer pregnancy, calving ease total maternal, stayability, maternal milk & growth, maternal milk, baldy maternal index, Brahman influence index, certified Hereford beef index, calving ease index, yield grade, gestation length, all purpose index, terminal index, grid merit, feedlot merit, docility, and/or mainstream terminal index.

Total Material (TM) is measured in pounds of calf weaned by an animal's daughters. TM accounts for average differences that can be expected from both weaning weight direct as well as from milk, and measure an animal's ability to transmit milk production and growth rate through its daughters. TM is calculated by adding an animal's Milk predictor to one-half of its Weaning Weight. Mature Cow Maintenance Energy Requirements (ME) is an assessment of the differences in animal's energy requirements.

Heifer Pregnancy (HPG) is an estimate of the differences in an animal's daughters'ability to conceive to calve as a two year old. HPG is expressed in terms of a percentage difference. Calving Ease Total Maternal (CETM) is expressed as a difference in percentage of unassisted births with a higher value indicating greater calving ease in first-calf daughters. CETM predicts the average ease with which an animal's daughters will calve as first-calf heifers when compared to daughters of other animals.

Stayability (ST) is expressed as the probability that an animal's daughters will remain in production to at least six years of age when compared to the daughters of another animal. A measure of sustained fertility that probably reflects traits such as fleshing ability and structural soundness. Expressed as deviations from a 50% probability, a higher value indicates increased stayability.

Maternal Milk & Growth (MG) expresses what the animal is expected to transmit to its daughters for a combination of growth genetics through weaning and genetics for milking ability. MG is an estimate of daughters'progeny weaning weight. Maternal Milk (MM) expresses the milking ability of an animal's daughters expressed in pounds of calf weaned. It predicts the difference in average weaning weight of animal's daughters'progeny due to milking ability.

Baldy Maternal Index (BMI$) is an index designed to maximize profit for commercial calf producers that use Hereford bulls in rotational crossbreeding programs on Angus based cows and heifers. Retained ownership of calves through the feedlot phase of production is assumed, with fed cattle marketed on a Certified Hereford Beef (CHB) program pricing grid.

Brahman Influence Index (BI$) is similar to BMI$, with one primary difference. Hereford bulls are used in rotational crossing with Brahman, rather than Angus. This index places greater emphasis on traits deficient in Brahman cross cattle, such as fertility and age at puberty, and less on traits that are more acceptable in those cattle, such as growth and calving ease.

Certified Hereford Beef Index (CHB$) is a terminal animal index, where Hereford bulls are mated to British cross cows and all offspring are sold as fed cattle on a CHB pricing grid. This index emphasizes growth at all stages along with carcass values. No emphasis is put on fertility or milk because replacements are not kept.

Calving Ease Index (CEZ$) is similar to BMI$, except that Hereford bulls are mated only to yearling heifers. This index has increased emphasis on direct and maternal calving ease compared with the other indexes. These indexes allow a breeder to utilize a specific target to make animal selections. The indexes also allow a breeder to select for a balance of traits without putting thresholds on individual traits. Yield Grade (YG) is a USDA yield grade estimate of beef carcass cutability, which is defined as the combined yield of closely trimmed, boneless retail cuts from the round, loin, rib and chuck.

Gestation Length (GL) predicts average differences in gestation length. Expressed in days. Shorter gestation lengths are associated with less dystocia and longer post-partum intervals. All Purpose Index (API$) evaluates animals being used on the entire cowherd (bred to both Angus first-calf heifers and mature cows) with a portion of their daughters being retained for breeding and the steers and remaining heifers being put on feed and sold grade and yield.

Terminal Index (TI$) evaluates an animal's economic merit in situations where they are bred to mature Angus animals and all offspring are placed in the feedlot and sold grade and yield. Grid Merit (GM) is the expected average difference in future progeny performance for carcass grid merit compared to progeny of other animals. Feedlot Merit (FM) is the expected average difference in future progeny performance for post-weaning merit compared to progeny of other animals.

Docility (DOC) is a prediction of the percentage of an animal's offspring that are expected to score favorably (1 or 2) on a five-point scoring system when compared to the offspring of another animal. Expressed as a percentage with higher values being favorable. Mainstream Terminal Index (MTI$) ranks animals under the assumption that Limousine-sired calves are sold into the commodity beef market with premiums and discounts based on both quality and yield.

As described above, the present invention provides an attractive graphic user interface (17) through which users may enter animal information (19). In one embodiment, such information may be categorized and stored according to ranch (19R), herd (19H), or pasture (19P), as illustrated by Box (37). Once animal information has been made available to the system, the user may browse a plurality of animal records and select a mating pair, as illustrated by Box (22). Once a mating pair has been selected, the processing unit of the present invention accesses animal information pertaining to each animal of the mating pair and performed the mating calculation, as illustrated by Box (26). Results of the mating calculation are then displayed for review by the user as illustrated by Box (28).

In one embodiment, the present invention provides a comprehensive animal propagation tool designed to provide the user with multiple mating options. In this embodiment, the storage device of the present invention is propagated with industry information containing progeny predictors for a plurality of animals in addition to the information provided by the user regarding his or her herd. In one embodiment, the system accesses and stores industry animal information. Such information provides progeny predictors for hundreds of animal specimens and may be accessed by the system in any known manner.

This feature of the present invention allows the system to conduct mating calculations for hundreds of potential mating specimens. For example, if the user enters information relating to a single female specimen, he may then select a group of male specimens taken from a reliable external information source. With a simple click of the mouse button, the system is capable of running calculations comparing the progeny predictors of the female specimen owned by the user to the progeny predictors of a plurality of male specimens stored upon the system or accessed from an external source.

In one embodiment, a single mating calculation is performed, then one of the animals within the selected mating pair is replaced, as illustrated by Box (26R). This process may be repeated until all of the males in the group selected by the user have been calculated in comparison to the user's animal. Comparative results (21) may then be displayed upon the graphic user interface (17) for review by the user.

Prior to running a mating calculation, the user my enter offspring preference information, as illustrated by Box (39). For example, if the user's business objective is to have animal offspring having a high weaning weight, described further below, he or she may prioritize (23) and/or optimize (25) this offspring characteristic prior to running a mating calculation. In one embodiment, the user may prioritize one or more progeny predictors by assigning a percentage emphasis to one or more traits.

Further, the present invention allows the user to maximize (27) or minimize (29) a particular characteristic. For example, it is often desirable to have animals exhibiting the lowest birth weight possible while, at the same time, having the highest weaning weight possible. In this example, the user would enter preference information maximizing the weaning weight predictor while minimizing the birth weight predictor prior to starting the mating calculation.

Animal industry information typically has an accuracy associated thereto. In short, the accuracy of industry information relating to a particular breed of animal may vary depending on the amount of information available regarding the animal's offspring and their individual performance data. Typically, the more data relating to a particular animal's offspring, the greater the accuracy of the progeny predictor associated with that animal.

In one embodiment, the user may assign a minimum accuracy value (30) to any and all of the progeny predictors utilized by the present invention in conducting a mating calculation. For example, if the user only wishes to consider animals having a minimum accuracy value of greater than 75%, the user would enter “0.75” into the data field corresponding to the progeny predictor at issue.

In one embodiment, the user's offspring preferences are taken into account and utilized by the system during the mating calculation(s), as illustrated by Box (40). Each mating calculation may be assigned a score (31) based upon the most likely qualities of the offspring as illustrated by Box (26C). In one embodiment, a score of between 0 and 100 is assigned to each potential mating pair.

Mating scores may be ranked (32) and/or graphed (34) in order to provide the user with a convenient arrangement of mating information from which to make his or her mating decisions. Such information may be stored for later use, as illustrated by Box (41).

The mating calculation(s) made possible by the unique functionality of the present invention utilize an average of the progeny predictors for the male and female of a mating pair to generate projected offspring progeny predictor values. For example, a male animal having a weaning weight predictor having a value of 43 matched with a female animal having a weaning weight predictor having a value of 37 would generate a calculated offspring weaning weight predictor value of 40.

After calculating the offspring's predictor values, the present invention continues by calculates a mating score (31) for the proposed match. To accomplish this, the system first selects the predictors indicated as important by the user, either through prioritization, optimization, maximization, and/or minimization. For example, let's assume for the purposes of illustration that the user selects the following offspring preferences:
Birth weight=15% priority, minimized,
Weaning weight=30% priority, maximized
Milk=10% priority, optimized with an optimized value of 20
% IMF=15% priority, maximized, and
$W=30% priority, maximized.

Note that the % priority entered by the user must equal 100%. In one embodiment, only the predictors set forth by the user in this example, i.e., BW, WW, Milk, % IMF, and $W will be utilized in calculating a mating score.

Electronic records pertaining to the animal at issue are accessed by the system to determine the maximum and minimum predictor values for each predictor. In this example calculation, let's assume maximum and minimum values for WW, % IMF and $W to equal 66, 74, and 100, respectively, while minimum value for BW is equal to 53. The optimum value entered by the user for the Milk predictor was 20. The projected progeny Milk predictor was determined to be 23 for this example. This figure is twenty percentage points above the optimal user Milk predictor as per the breed association's, in this case the American Angus Association, percentile rank chart. Because the projected progeny's Milk predictor is 20 percentage points away from the user's optimal predictor value (with optimum points for the trait being 100), the total mating points for this calculation would be 80.

The above example yields individual predictor scores of 53 for BW, 66 for WW, 74 for % IMF, 80 for Milk, and 100 for $W. Each of these values must them be multiplied by the % priority as defined by the user. In this example, such calculations comprise:
BW score=53*0.15=8.0;
WW score=66*0.3=19.8;
% IMF score=74*0.15=11.1;
$W score=100*0.3=30.0; and,
Milk score=80*0.1=8.0.

In embodiment, individual scores for each predictor selected by the user are added to equal a total mating score of 8.0+19.8+11.1+30.0+8.0=76.9 out of 100. As described above, this mating score may be displayed for review by the user as well as ranked for comparative analysis with other mating calculations.

Although the invention has been described with reference to specific embodiments, this description is not meant to be construed in a limited sense. Various modifications of the disclosed embodiments, as well as alternative embodiments of the invention, will become apparent to persons skilled in the art upon reference to the description of the invention. It is, therefore, contemplated that the appended claims will cover such modifications that fall within the scope of the invention.

We claims:

1. A method of facilitating animal propagation comprising the steps of:
accessing one or more records containing characteristics pertaining to the offspring of a plurality of animals;
selecting a mating pair from said plurality; and
utilizing one or more of said records, calculating one or more characteristics attributable to the potential offspring of said mating pair.

2. The method of claim 1, wherein said characteristics comprise one or more progeny predictors.

3. The method of claim 2, wherein said progeny predictors comprise calving ease direct, birth weight, weaning weight, yearling weight, yearling height, scrotal circumference, calving ease maternal, maternal milk, mature weight, mature height, energy value, carcass weight, marbling, ribeye area, percent retail product, intramuscular fat, fat thickness, weaned value, feedlot value, grid value and/or beef value.

4. The method of claim 3, wherein said progeny predictors further comprise total maternal, mature cow maintenance energy requirements, heifer pregnancy, calving ease total maternal, stayability, maternal milk & growth, maternal milk, baldy maternal index, Brahman influence index, certified Hereford beef index, calving ease index, yield grade, gestation length, all purpose index, terminal index, grid merit, feedlot merit, docility and/or mainstream terminal index.

5. The method of claim 1, further comprising the additional step of categorizing one or more of said records according to ranch, pasture, and/or herd.

6. The method of claim 2, further comprising the additional step of receiving offspring preference information.

7. The method of claim 6, wherein said offspring preference information further comprises prioritizing, maximizing, and/or minimizing one or more of said progeny predictors.

8. The method of claim 7, wherein said offspring preference information further comprises a minimum accuracy value for one or more of said progeny predictors.

9. The method of claim 8, further comprising the additional step of incorporating said offspring preference information into said calculation.

10. The method of claim 2, further comprising the additional steps of:
replacing one or more animals of said mating pair; and
repeating said calculation step.

11. The method of claim 10, further comprising the additional step of displaying the results of said calculation.

12. The method of claim 11, further comprising the additional steps of
ranking the results according to one or more predetermined factors; and
storing said results.

13. The method of claim 2, further comprising the additional steps of:
providing a database for storing said records, said database being accessible via a computer network;
providing a processing unit capable of executing a plurality of calculations, said database being coupled to said database; and
providing one or more websites through which remote users may access said database.

14. An apparatus for facilitating animal propagation comprising:
a database containing a plurality of electronic records, said database being accessible via a computer network; and
a processing unit coupled to said database, said processing unit being capable of receiving input information from a remote user, accessing one or more electronic records containing characteristics pertaining to the offspring of a plurality of animals, selecting a mating pair from said plurality and, utilizing one or more of said records, and calculating one or more characteristics attributable to the potential offspring of said mating pair.

15. The apparatus of claim 13 wherein said characteristics comprise one or more progeny predictors.

16. The apparatus of claim 15, wherein said progeny predictors comprise calving ease direct, birth weight, weaning weight, yearling weight, yearling height, scrotal circumference, calving ease maternal, maternal milk, mature weight, mature height, energy value, carcass weight, marbling, ribeye area, percent retail product, intramuscular fat, fat thickness, weaned value, feedlot value, grid value and/or beef value.

17. The apparatus of claim 16, wherein said progeny predictors further comprise total maternal, mature cow maintenance energy requirements, heifer pregnancy, calving ease total maternal, stayability, maternal milk & growth, maternal milk, baldy maternal index, Brahman influence index, certified Hereford beef index, calving ease index, yield grade, gestation length, all purpose index, terminal index, grid merit, feedlot merit, docility and/or mainstream terminal index.

18. The apparatus of claim 17, wherein said processing unit is for receiving offspring preference information.

19. The apparatus of claim 18, wherein said offspring preference information comprises prioritizing, maximizing, and/or minimizing one or more of said progeny predictors.

20. The apparatus of claim 19, wherein said offspring preference information comprises a minimum accuracy value for one or more of said progeny predictors.

21. The apparatus of claim 18, wherein said processing unit is for replacing one or more animals within said mating pair; and for repeating said calculation step.

22. The apparatus of claim 21, wherein said processing unit is for ranking the results of said calculation step according to one or more predetermined factors, storing said results, and displaying said results.

23. A method of facilitating animal propagation comprising the steps of:
a) providing a database for storing said electronic records, said database being accessible via a computer network;
b) providing a processing unit coupled to said database;
c) providing one or more websites through which remote users may access said database;
d) populating said database with a plurality of electronic records containing characteristics pertaining to offspring of a plurality of animals, wherein at least a portion of said electronic records pertain to animals belonging to one or more remote users, wherein at least a portion of said electronic records are categorized according to ranch, pasture, and/or herd, wherein one or more of said characteristics comprise one or more progeny predictors;
e) receiving offspring preference information from one or more remote users, said preference information comprising prioritization, maximization, and/or minimization of one or more of said progeny predictors;
f) accessing one or more of said electronic records;
g) selecting a mating pair from said plurality;
h) utilizing one or more of said records, calculating one or more characteristics attributable to the potential offspring of said mating pair;
i) replacing one or more of said animals within said mating pair; and
j) repeating step h) to generate a plurality of results;
k) repeating steps i) and j);
l) displaying the results of each of said calculations;
m) ranking the results of said calculations according to one or more predetermined factors;
n) storing said results; and
o) displaying said results.
